(19) United States
(12) Patent Application Publication
(10) Pub. No.: US 2004/0218263 A1
(43) Pub. Date: Nov. 4, 2004

(54) Digital microscope

(76) Inventor: Gerard Brugal, Lumbin (FR)

Correspondence Address: DUANE MORRIS LLP, 100 COLLEGE ROAD WEST, SUITE 100, PRINCETON, NJ, 08540-6604, US

(21) Appl. No.: 10/474,277

(22) PCT Filed: Apr. 9, 2002
(86) PCT No.: PCT/FR02/01240

(30) Foreign Application Priority Data
Apr. 9, 2001 (FR) 01/04777

(51) Int. Cl. G02B 21/00

(52) U.S. Cl. 359/368; 359/392

(57) ABSTRACT

The invention relates to a method and device for controlling drive units (26, 27, 28, 29, 31, 34, 36, 37, 38, 39) in a printing machine, whereby during continuous production and in anticipation of a foreseeable disruption, one or more measuring values (m) suitable for characterising the disruption are determined. The measuring values are used to estimate the expected variations (Δx; Δy) caused by said disruptions in the variables influencing the printing process and said variables are preregulated or precontrolled directly before the start of the disruption or during the disruption.

The present invention relates to instrumentation in the field of microscopy. More specifically, the present invention relates to a microscope capable of being used as an observation and measuring instrument.

Microscopes are used in a great number of applications, for the observation as well as for the measurement by microscopic image analysis in biology and in medicine. Since they were first designed, microscopes have evolved essentially in terms of quality of the optics enabling improvement of the depth of focus, of the size of the observed field, and of the lens error correction. It remains however dedicated to the direct observation by an observer.

This situation now has many disadvantages.

First, there is a problem of preparation storage. Indeed, once an observer has finished studying a preparation, to be able to reuse it later, he has to store it. Each preparation is formed of the stacking of a glass slide, of an object to be observed, and of a glass cover slip, the cover slip being sealed on the slide with resin. Such stackings are particularly fragile, bulky and heavy. The quantity and the nature of such preparations managed by a single laboratory are such that specific installations are required for their storage, such as reinforced grounds, temperature, humidity controls, etc. This is disadvantageous in financial terms as well as in terms of lack of flexibility. Indeed, it is of little convenience, if not impossible, to transfer samples in simple fashion. This limits the information dissemination and imposes a proximity between the observer and the samples.

Such a localized and sedentary character of microscopy is further enhanced by an initial step of detection of the location of the objects to be observed within the sample. This preliminary step imposes the exploration of the entire available sample and cannot be performed remotely.

Another disadvantage consists in the variations of the obtained results in circumstances which should a priori be similar. Indeed, in a microscopic image analysis, such as an analysis of the DNA-ploidy of tumors or of the intensity of enzyme-linked immunosorption markers, the microscope settings are performed by the specific user using the microscope (light intensity, color temperature, contrast diaphragm, field diaphragm). These settings are performed according to the diagnosis approach specific to the observer. Further, their memorization is not systematic. Re-using data obtained by a specific observer is poorly successful. Accordingly, a new analysis imposes a new observation of the original sample.

To overcome these problems, it has been provided to use digitizing facilities. However, the first attempts of constructing microscopic image databases by digitizing images provided by different observers are very variable in terms of quality. This digital image inequality is partly due, as previously discussed, to approximate settings of the microscope specific to each observer. On the other hand, such settings as convenient for an eye are generally not convenient for collection and digitization systems. The resulting images exhibit a contrast, colors, a luminosity, or a resolution which are unsatisfactory for a distant observer. Further, the images so obtained are not or scarcely reproducible, even by a same observer. Also, the image-shooting requirement has been solved by adding digitization facilities to a traditional microscope. The overall system is particularly bulky and expensive. Further, current systems are slow and only enable acquiring partial images of a preparation.

Further, the obtained images are images preselected by an observer in the context of a determined therapeutic or diagnosis approach. A new approach then often imposes a new analysis of the sample.

Remotely-controlled microscopes have also been provided. However, as for digitization devices, the components necessary, for example, for the control, are added to a traditional microscope. The resulting device is particularly bulky and expensive, all the more as the current equipment imposes very long image acquisition times.

It has further been provided to use document digitization systems, modified to be able to receive microscopic preparations. Such devices have the disadvantage of a reduced optical resolution. Indeed, only elements having a dimension greater than 10 μm can be observed by means of such devices. Below, the digital processes implemented to magnify the acquired images exhibit low performances. Further, higher-performance current scanners have a relatively long image acquisition time, on the order of several minutes to obtain a full image of a preparation with a 10 μm-per-pixel resolution.

The present invention accordingly aims at providing a microscope which overcomes the previously-discussed problems.

Especially, the present invention aims at providing such a microscope which provides images of an optimal defined quality.

The present invention also aims at providing such a microscope which provides reproducible images.

The present invention also aims at providing such a microscope which provides full and/or partial images of a preparation.

The present invention also aims at providing such a microscope that can be used as an observation device as well as a measurement instrument.

The present invention also aims at providing such a microscope, the settings of which are performed either self-sustainedly, or under control of the observer.

The present invention also aims at providing such a microscope capable of being used remotely in self-sustained or controlled fashion.

To achieve these objects, the present invention provides a microscope comprising at least one optical device for magnifying a preparation slide placed on a rectangular slot so that the entire length of the slide covers at least partially the slot length, the slot width being smaller than that of the slide, further comprising:

a means for moving the optical device lengthwise over the slot along this entire length;

a slide holder for moving the slide widthwise over the slot across the entire slide width;

a digital camera associated with the optical device; and

a means for reconstructing a partial or full image of the slide, based on the succession of lines and columns filmed by the camera during the motions of the device and of the slide holder.

According to an embodiment of the present invention, the at least one optical device comprises first and second immovably attached portions, capable of passing, respectively, under and over the rectangular slot upon displacement of the device, the first portion comprising at least one lighting device and the second portion comprising at least one objective placed on the optical axis defined by the lighting device and the slot.

According to an embodiment of the present invention, the lighting device of the first portion comprises at least one light source.

According to an embodiment of the present invention, at least one light source is assembled on the optical device.

According to an embodiment of the present invention, at least one light source is external to the device and an optical fiber brings into the first portion of the magnifying optical device the beam emitted by the source.

According to an embodiment of the present invention, at least one light source is a continuous source.

According to an embodiment of the present invention, at least one light source is a pulsed source.

According to an embodiment of the present invention, the lighting device further comprises a focusing lens, attached in the first portion of the magnifying optical device, whereby a light beam originating from the light source is condensed towards the slot.

According to an embodiment of the present invention, the lighting device further comprises a diaphragm interposed between the lens and the slot.

According to an embodiment of the present invention, the second portion of the magnifying optical device comprises a plurality of objectives and a selection means capable of placing a single one of the objectives on the optical axis.

According to an embodiment of the present invention, the selection means comprises a step-by-step controllable motor capable of moving perpendicularly to the optical axis a drawer containing the plurality of objectives.

According to an embodiment of the present invention, the second portion of the optical device further comprises a self-focusing means for moving the objective along the optical axis.

According to an embodiment of the present invention, the self-focusing means comprises a laser diode placed on the optical axis above the objective, a piezo-electric element associated with the objective and controlled by the reconstruction means.

According to an embodiment of the present invention, the means for displacing the magnifying optical device comprises at least one control element driven by a step-by-step controllable motor.

According to an embodiment of the present invention, the microscope comprises two magnifying optical devices, a first high-magnification device and a second low-magnification device, each device being associated with its own displacement means.

According to an embodiment of the present invention, the slide holder is rectangular and exhibits a U shape of a length at least equal to that of a slide.

According to an embodiment of the present invention, a control element connects a stop portion of a slide in the slide holder to a step-by-step motor controllable by the reconstruction means.

According to an embodiment of the present invention, the slide holder further comprises a fixed portion supporting an optotype.

According to an embodiment of the present invention, the means for moving the optical device and the slide holder for moving the slide output their position in real time to the reconstruction means.

According to an embodiment of the present invention, the digital camera is a CMOS camera.

According to an embodiment of the present invention, the digital camera associated with the magnifying optical device is placed in the second portion thereof.

According to an embodiment of the present invention, the second portion further comprises a means for transmitting to the digital camera the light beam coming out of the objective.

According to an embodiment of the present invention, the transmission means is a semitransparent plate.

According to an embodiment of the present invention, a diaphragm is interposed between the semitransparent plate and the digital camera.

The foregoing objects, features, and advantages of the present invention will be discussed in detail in the following non-limiting description of specific embodiments in connection with the accompanying drawings, in which:

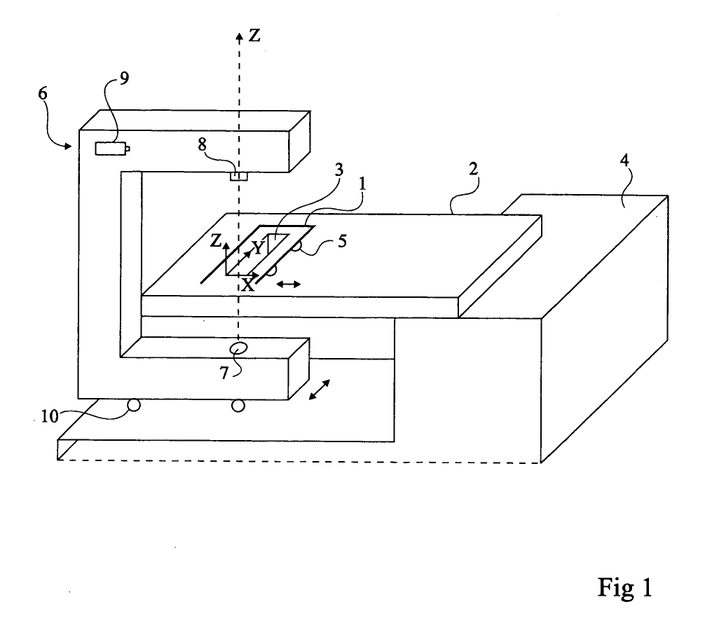

FIG. 1, previously described, schematically illustrates a microscope according to the present invention;

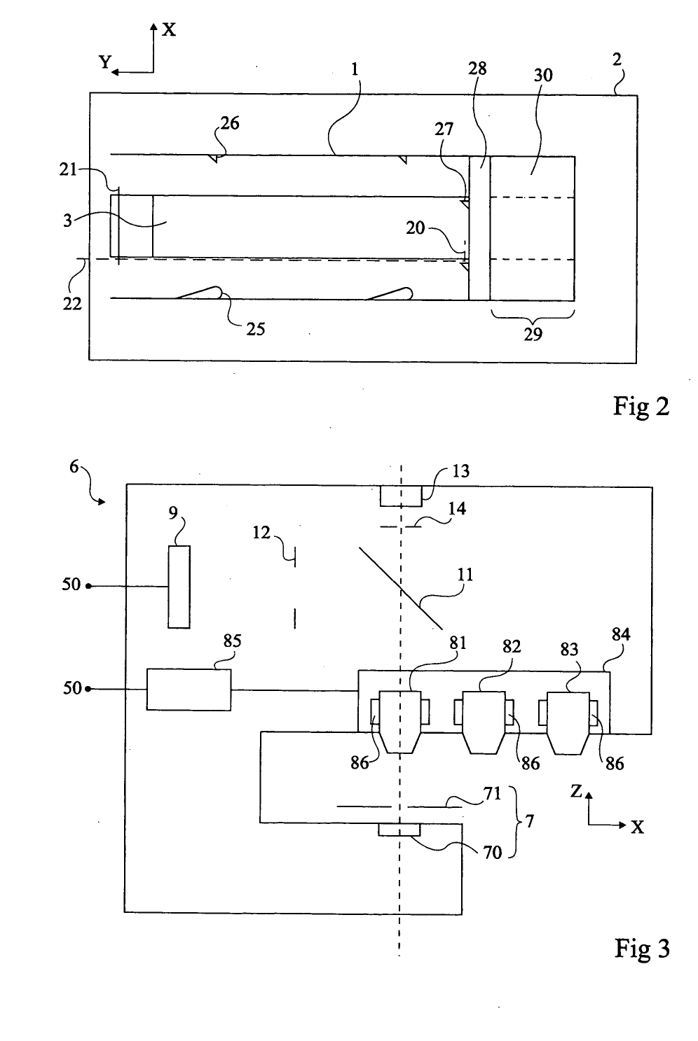

FIG. 2 illustrates, in top view, a support element of a microscopic preparation according to the present invention;

FIG. 3 schematically illustrates a read head of a microscope according to the present invention;

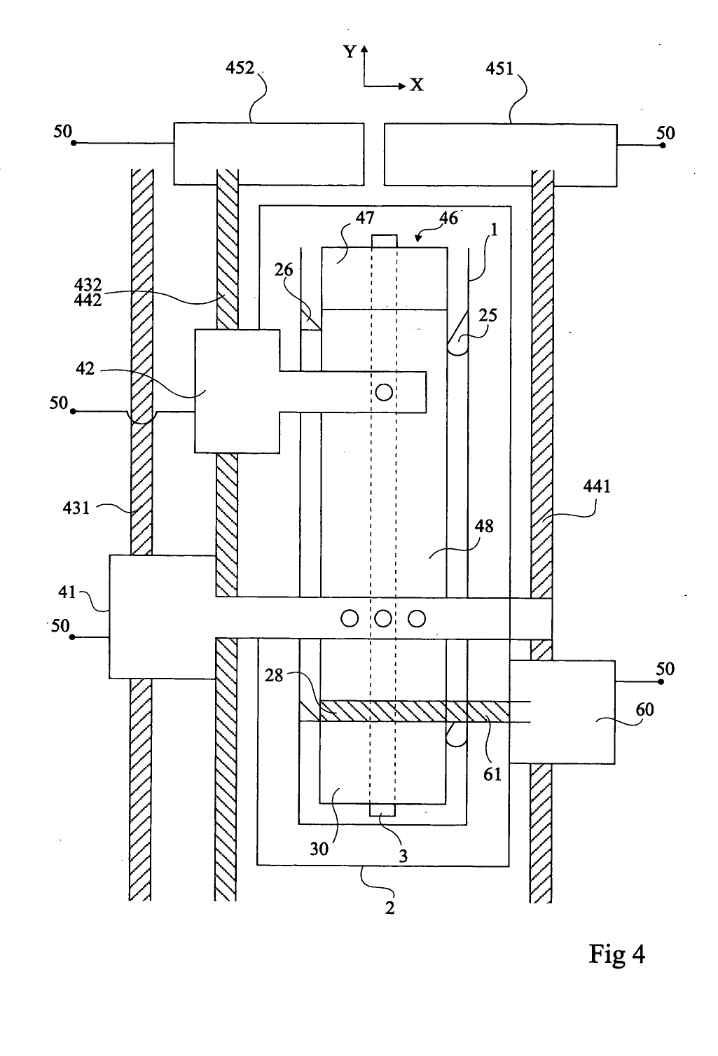

FIG. 4 schematically and partially illustrates an embodiment of the present invention.

In the different drawings, same elements have been designated with same reference numerals. Further, the various drawings are not to scale.

Hereafter, “slide” will be used to designate the traditional assembly of a microscopic preparation formed, as previously described, of the stacking on a glass slide of an object and of a glass cover slip, the cover slip being sealed with resin on the slide.

A microscope according to the present invention essentially comprises an element capable of receiving a slide (not shown) or “slide holder”, at least one optical magnifying device or “read head”, and a reconstruction means. The structure and the cooperation of these three elements will appear from the following description of FIGS. 1 to 4.

FIG. 1 is a simplified partial perspective view of the internal structure of a microscope according to the present invention.

A rectangular slide holder 1 rests upon a substantially horizontal plate or stage 2. Plate 2 comprises a rectangular slot 3. The length of slot 3 is at least equal to that of slide-holder 1. The width of slot 3 is however smaller than that of a slide. The axis defined by the width of slot 3 will be designated hereafter as X and the axis defined by the length of this slot as Y. The axis perpendicular to plane XY will be designated as Z. Slide holder 1 is placed parallel to slot 3, above it, so that their lengths superpose.

Plate 2 is fixed, as indicated in FIG. 1, by firmly attaching it to a fixed base 4. Slide holder 1 is mobile with respect to plate 2 along axis X. The mobility of slide holder 1 with respect to plate 2 is symbolized in FIG. 1 by small wheels 5. The displacement of slide holder 1 above slot 3 is performed across at least the entire width of a slide. Thereby, all points of a slide can be placed above slot 3. The successive positions of slide holder 1 are provided to the reconstruction means (not shown). Preferably, said means controls the displacement of slide holder 1.

The microscope according to the present invention also comprises an optical magnifying device or read head 6. The complete structure of head 6 will be detailed hereafter in relation with FIG. 3. However, it should already be noted that head 6 comprises at least one lighting device 7 in a low portion and at least on objective 8 in a high portion. Lighting device 7 and objective 8 are placed on a same vertical line. The output of objective 8 is associated with a digital camera 9 placed in the high portion of head 6. Camera 9 is associated to the reconstruction means (not shown) to supply it with any filmed image and receive from it any appropriate control signal. The high and low portions move along as follows.

Head 6 is mobile with respect to base 4. This mobility of head 6 is symbolized in FIG. 1 by small wheels 10. Read head 6 is mobile in horizontal plane XY only along axis Y, that is, along the length of slot 3. Head 6 is C-shaped and is arranged so that, as it moves, lighting device 7 passes under plate 2 and objective 8 passes above. More specifically, the structure of head 6 and its position with respect to plate 2 are such that the vertical line running through lighting device 7 and objective 8 crosses slot 3. The vertical line coming from lighting device 7 and crossing slot 3 will be called the “optical axis” hereafter. Upon displacement of head 6, the optical axis follows the length of slot 3. Head 6 can be displaced along at least the length of a slide. Preferably, front end 6 is mobile along the entire length of slot 3. The successive positions of head 6 are provided to the reconstruction means. Preferably, said means itself controls the displacement of head 6.

Slide holder 1 and head 6 are associated with a reconstruction means (not shown) having the following function. After introduction of a slide into slide holder 1, the latter and head 6 are displaced as described hereabove. Thus, camera 9 scans the entire slide surface. Based on the succession of lines and columns provided by camera 9 and based on the position information provided by slide holder 1 and head 6, the reconstruction means reconstructs an image of the slide. This image is either a full image if head 6 comprises a low-magnification objective 8, or a full or partial image in the case of a head 6 comprising a high-magnification objective 8.

The reconstruction means also stores all the data relative to the conditions of the image acquisition such as, for example, the type of lighting device 7, the type of objective 8, or information relative to the system stability, some of which will be detailed hereafter in relation with FIGS. 3 and 4.

FIG. 2 illustrates, in a simplified partial top view, the portion of plate 2 of FIG. 1 comprising slot 3 and slide holder 1. Slide holder 1 has an open horizontal U shape (or stirrup shape) to enable introduction and retrieval of a slide. The dimensions of slide holder 1 are at least equal to those of a slide. The stabilization of the slide in slide holder 1 is reproducibly ensured as follows.

A receive and eject device similar to that of a computer floppy disk enables introduction or retrieval of a slide. This device comprises an eject pin 20 and a pusher 21, attached together by means of a lever 22. The receive and eject device is attached to plate 2. Pin 20 is in slot 3, lever 22 under plate 2 separate from slot 3. Pusher 21 cooperates with lever 22 so that it is in slot 3 after introduction of a slide.

Upon introduction of a slide (not shown), said slide reaches the bottom of slide holder 1, abuts against pin-20 that it pushes. This pushing raises lever 22 and brings pusher 21 back to the back of the slide. The slide positioning is reproducibly ensured by the cooperation of pin 20, of pusher 21, of lateral springs 25, of lateral toes 26 and of end toes 27. Springs 25, present on a single side of slide holder 1, push the slide back towards toes 26 arranged on the opposite side of slide holder 1. End toes 27, mounted on the closed end portion 28 of the horizontal U forming slide holder 1, ensure with pin 20 a stopping of the slide. Pusher 21 and pin 20 remain fixed upon displacement of the slide holder. Upon retrieval of a slide, pusher 21 is released, lever 22 lowers and the slide is ejected. This ejection is performed rectilinearly due to springs 25 and to toes 26.

According to an embodiment of the present invention, the operations of slide introduction or retrieval are automated by adding to the device a slide loader.

According to an embodiment, slide holder 1 comprises an element attached to terminal portion 28 capable of cooperating with a displacement means. For example, end portion 28 will be indexed to cooperate with an endless screw system controlled by a step-by-step motor (not shown).

According to an embodiment, slide holder 1 comprises, also beyond slide stop end portion 28, a fixed portion 29. Slot 3 is then designed to also run under fixed portion 29. The displacement of slide holder 1 is then ensured either by a limiting end portion, beyond fixed portion 29, or, preferably, by the median portion between the portion supporting a slide and fixed portion 29. Fixed portion 29 also comprises a test element 30 or “optotype” formed of a plurality of transparent, semi-transparent, or opaque regions, as well as of various engraved or colored elements. The function of such an optotype 30 will be detailed hereafter in relation with FIG. 4.

FIG. 3 illustrates, in a partial simplified cross-section view, an embodiment of a read head 6 of a microscope according to the present invention such as that in FIG. 1.

The low portion of head 6, capable of running under slot 3 (FIG. 1), comprises a lighting device 7 comprising a focusing lens 70 and a field diaphragm 71. Diaphragm 71 is interposed between the output of lens 70 and slot 3. Lens 70 condenses a light beam originating from a light source (not shown), the features of which will be described hereafter.

On the other side of slot 3 with respect to lighting device 7, head 6 comprises at least one objective, for example, three objectives 81, 82, and 83. The different objectives 81, 82, and 83 are distributed to be able to selectively place one of them, for example, 81, on optical axis 7-3. Active objective 81 is replaceable at any moment by any one of the other objectives 82 and 83. The selection of the active objective will be discussed hereafter.

A light beam from lighting device 7 having crossed a slide (slot 3) and an active objective 81 is then directed to digital camera 9.

According to an embodiment, such a transmission is not direct, but is performed via a semitransparent plate 11 which reflects the beam output by objective 81 to camera 9. Preferably, a field diaphragm 12 is interposed between semitransparent plate 11 and camera 9. Camera 9 is connected, as discussed previously, to reconstruction means 50.

The features of the light source depend on the desired magnification, that is, on the active objective and on the desired acquisition speed. Indeed, it is known that the higher the desired magnification, the higher the light intensity must be. For small magnifications, that is, typically, an objective from 2×to 10×, for example, 4×, the lighting device may be assembled in the low portion, directly under lens 70. Beyond a given magnification, generally 10×, the light intensity involved imposes light sources of limited lifetime and generating a significant heating. It will then be preferable to use such a source external to head 6, the light beam necessary to the observation being brought to the level of lens 70 by an optical fiber device. This eases the handling, limits the head bulk, and keeps the different components of the overall device from heating.

The light source preferably is a continuous white source, for example, a 100-W halogen lamp. However, to enable accelerated acquisition in certain applications, especially imposing an image capture with a frequency greater than 100 Hz, the source will preferably be a pulsed laser diode.

The selection of the used source is performed either automatically by reconstruction means 50, or by a control from an observer. Reconstruction means 50 records the lighting conditions upon image acquisition.

According to an embodiment of the present invention, the selection of objective 81 placed on optical axis 7-3 is performed as follows. Objectives 81, 82, and 83 are placed in a housing or drawer 84 next to one another, linearly, for example, along axis X of the width of slot 3. Drawer 84 is mobile along the distribution axis of objectives 81, 82, and 83, for example, axis X. Drawer 84 is connected to a driver 85. Driver 85 is connected to reconstruction means 50 to receive an instruction for selecting an objective. Such an instruction is transmitted by reconstruction means 50 either automatically, or under request of an observer.

According to an alternative not shown, objectives 81, 82, and 83 are placed on a turret mobile along an axis offset with respect to optical axis 7-3. The turret is then connected to a driver similar to driver 85. The selection is performed by a control similar to those described hereabove.

According to an embodiment of the present invention, active objective 81 is mobile along the optical axis. The selection of the position of active objective 81 on optical axis 7-3 is performed as follows. A displacement element, preferably a piezo-electric element 86, is associated with objective 81. Piezo-electric element 86 is controlled by reconstruction means 50. Reconstruction means 50 provides such a control signal either under instruction of the observer, or automatically. In this latter case, the position of the active objective 81 will be determined due to an automatic focusing means.

According to an embodiment of the present invention, the automatic focusing means comprises a laser diode 13 placed on optical axis 7-3, on the other side of semitransparent plate 11 with respect to the output of active objective 81. Preferably, a diaphragm 14 is interposed between laser diode 13 and semitransparent plate 11. In an automated focusing, laser diode 13 emits a light beam on optical axis 7-3. This beam crosses semitransparent plate 11 and active objective 81 and reaches a slide (not shown) placed on slot 3. The beam then successively crosses the upper surface of the cover slip, the lower surface of the cover slip, the object to be observed, the upper surface of the glass slide and the lower surface of the glass slide. At each crossing of an interface between two different media, a portion of the light beam is reflected. These reflected beams are sent to objective 81, reach semitransparent plate 11 which reflects them to digital camera 9, which transmits them to reconstruction means 50. According to the position of objective 81 on optical axis 7-3, light-density peaks successively corresponding to the reflections will then be observed. These peaks are known. Reconstruction means 50 then controls piezo-electric element 86 to vary the position of objective 81 between the two positions corresponding to the reflections on the lower surface of the cover slip and on the upper surface of the slide, that is, to optimize the contrast in the field corresponding to the object to be observed.

According to an embodiment of the present invention, digital camera 9 is a camera in CMOS technology.

Many modifications may be brought to the read head such as described previously in relation with FIG. 2. Especially, although a low-magnification objective may be provided in drawer 85, it is advantageous according to the present invention to dissociate a read head enabling strong magnification (high resolution) from a read head enabling low magnification (low resolution). Indeed, a low magnification imposes less constraints than a strong magnification, especially in terms of lighting as well as of contrast. A low-magnification head according to the present invention thus has a simplified design. Thus, it will require neither a displacement device (piezo-electric element 86) on the optical axis of the active objective, nor accordingly, an automated focusing means. Further, a low-magnification device standardly is a single objective with a magnification ranging between 1× and 4×. Drawer 84 and driver 85 are then no longer necessary. A low-resolution head according to the present invention will thus preferably comprise a single fixed objective. Dissociating a low-magnification head from a strong-magnification head such as described previously in relation with FIG. 2 has many advantages which will be detailed hereafter in relation with FIG. 4. It should already be noted that the use of two heads enables reducing the bulk and the complexity of the structure of a single multi-objective and multifunction head.

FIG. 4 illustrates, in a partial simplified top view, an embodiment of a microscope according to the present invention with two read heads 41 and 42.

First head 41 is a strong-magnification head comprised of several objectives, for example, three, for example 10×, 20× and 40×, of a structure such as, for example, that described previously in relation with FIG. 3. Second head 42 however is a low-magnification head comprised of a single fixed objective, for example, a 4× objective, of simplified structure as compared to first head 41, as described previously in relation with FIG. 3. Head 41 is mobile on at least one shim guide 431 and moves along with a control element 441 controlled by a step-by-step motor 45 driven by reconstruction means 50. Similarly, a motor 46 controlled by reconstruction means 50 enables moving head 42 along at least one shim guide 432, via a control element 442. For simplification, head 42 has been associated with a single adjustment and control guide in FIG. 4. As many shim guides 43, 47 as necessary will be provided to ensure the stability of heads 41, 42. For example, the head of FIG. 3 is associated with two shim guides crossing, one in the low portion under lighting device 7 and one in the high portion, above and to the right of drawer 84 of FIG. 3. The control will for example be an endless screw associated with motor 45, 46 running, for example, the low portion under camera 9. Preferably, the displacement speed of each head 41, 42, is controllable by reconstruction means 50.

According to an embodiment of the present invention (not shown), one of the adjustment and/or control guides 43, 47 of each read head is a ruler provided with optical marks. Such marks enable reconstruction means 50 to accurately place the considered read head with a 0.1-μm accuracy.

FIG. 4 also illustrates plate 2 and slot 3, a slide 46 being in position in slide holder 1. Slide 46 comprises a tag portion 47 and a “useful” portion 48.

FIG. 4 also shows a step-by-step motor 60 associated with an endless screw 61, cooperating with median portion 28 of slide holder 1 to displace the latter along axis X, as described previously in relation with FIG. 2.

The processing of a preparation by means of a microscope according to an embodiment of the present invention is the following.

First, a slide is introduced, either manually, or by means of a slide loader, as described previously in relation with FIG. 2.

Low-magnification device (low resolution) 42 then performs a first scanning of this slide. This scanning starts with tag portion 47 in which are written identification references of the preparation being visualized. Then, by a previously-described combination of displacements of slide holder 1 and of head 42, a full and relatively lightly magnified image of the preparation is reconstructed by means 50. This image will be called hereafter the “navigation image”. This navigation image is either archived, or presented (display) to an observer, or both.

At the end of the navigation image acquisition phase, the microscope according to the present invention brings low resolution (low magnification) read head 42 to its garage position, which is outside useful portion 48, preferably above tag portion 47. The system then switches to a high-magnification mode and enables head 41. By the combined motions of slide holder 1 and of head 42, new images of the slide are then acquired. These images advantageously exhibit a maximum resolution and a very fast acquisition time. Preferably, the displacement of head 41 avoids tag portion 47. However, head 41 may move above fixed portion 29 comprising optotype 30. Preferably, the garage position of head 41 is located straight above optotype 30.

According to an embodiment of the present invention, the acquisition of successive images of strong magnification is performed automatically for all available objectives and for the entire slide 46. This enables forming a complete database. Each of the strong-magnification acquisitions is then performed much faster than in present devices, with a much greater accuracy. Further, the optical quality of the images and the accuracy of the measurements that can be performed is evaluated in reliable and objective fashion, as will be described hereafter.

According to an embodiment of the present invention, the acquisition of successive strongly-magnified images is performed on-line, selectively, by an observer. Indeed, as seen previously, low-magnification device 42 starts acquiring the navigation image. It is thus possible for an observer to select a pathologically or diagnostically interesting portion and to limit the scanning of high-resolution head 41 to a reduced area of slide 46. It will further be possible for him to very rapidly select the desired objective. The automatically and immediately digitized navigation image is restorable on a display either in the immediate vicinity of the microscope according to the present invention, or remotely via a computer network. Further, the control of the reconstruction means is totally digital, and may thus also be performed remotely via a computer network. The observer is thus advantageously no longer forced to be in the immediate vicinity of the microscope.

This first phase already exhibits two major advantages as compared to homologous existing solutions (scanner). On the one hand, the resolution is much finer. On the other hand, the microscope according to the present invention can be placed in a location remote from the observer.

Upon a change of objective, the lighting and positioning adjustments of the objective on the optical axis are carried out automatically by means of the self-focusing device and of the optotype placed on the slide holder, as described previously in relation with FIG. 2. The different settings are memorized by the reconstruction means and associated with the concerned image.

At more or less regular intervals, predetermined by the construction means and possibly modifiable by a user, the microscope according to the present invention may perform a number of objective tests relating to the optical quality of the microscope. These tests may be carried out for different types of objectives. To carry them out, reconstruction means 50 performs a measurement by acquiring, as described previously (combined displacements of the slide holder and of head 42), an image of one or several selected parts of optotype 30. Then, a comparison with reference data enables evaluating the system stability.

Once the results are obtained and archived, the reconstruction means may, according to previously-set conditions that may be modified by an observer, either indicate to the observer a state of perfect device operation, or indicate a malfunction thereof, specifying what parameter(s) is (are) deviant.

If tests reveal a malfunction, a possibility of automatic correction by the computer system may be provided, either by a purely digital processing, or by a modification of acquisition conditions, for example an increase or a decrease in the intensity of the light source, or again a displacement of the objective. However, it may also be provided to limit the possibilities of automated intervention of the system or to submit them to an approval of an observer.

Several tests may thus be performed with variable frequencies. Thus, certain stability tests will only be performed at the microscope starting, while tests of field homogeneity, of reproducibility of spatial differences, of random lighting local instability, of stoechiometry contrast drift, of linearity, of morphometry reproducibility (measurement of a surface or of a length) and photometric tests, are carried out at more regular time intervals during the reader operation, for example once per hour or upon each change of microscopic preparation.

The different results of the various tests, as well as the possible modifications of acquisition conditions, are memorized and associated with each image. The microscope according to the present invention thus advantageously provides images of optimal optical quality and defined in absolute fashion.

An advantage of dissociating high magnification heads 41 and low magnification heads 42, in addition to the complexity reduction, is the following. Head 42 is relatively stable and preset upon manufacturing. However, the quality of the images provided by head 41 must be optimal. Its operation must thus be checked by means of tests carried out as described hereabove. Dissociating the heads enables acquiring the navigation image during at least part of the tests on head 41, which shortens the acquisition time.

The images obtained by means of a microscope according to the present invention are advantageously perfectly reproducible. Their optical quality is optimized, and the exact conditions of their acquisition are memorized in absolute fashion by the reconstruction means. This enables overcoming the previously-described problems of individual variations linked to the use by a given observer. Further, as indicated previously, the microscope according to the present invention can evaluate the optical quality of images, or even improve it, while keeping track of this improvement.

Another advantage of the present invention is the interactivity with an observer. Indeed, conversely to a scanner-type device, the observer can intervene at any time via the reconstruction means to modify the acquisition conditions. Further, the system can memorize these modifications in absolute fashion.

Another advantage of the present invention is to enable combining the observation system and an archiving system.

Another advantage of a microscope according to the present invention is to both be an observation system enabling an observer, distant or not, to get the general outlook of a preparation and to also form a measurement instrument. This measurement instrument advantageously is an automatically standardized instrument. Indeed, by means of the optotype, and of tests such as described hereabove, it is possible de automatically detect and evaluate, or even correct, a possible drift of the system. This limits the possibilities of differences between results.

Another advantage of a microscope according to the present invention is its ergonomics. Indeed, the entire previously-described device will fit in a reader having a bulk on a working space of approximately 30×20 cm. It has the advantage of being much less bulky in terms of height than a current microscope.

As a non-limiting comparative example, features of the main elements and of the performances of a microscope according to the present invention such as illustrated in FIG. 4 are detailed hereafter.

The slides typically have a width from 25 to 30 mm, generally standardized to 26 mm, for a length on the order of from 75 to 80 mm, generally standardized to 76 mm, with a tag area on the order of from 15 to 20 mm, generally 16 mm.

The slot will have a width ranging between 3 and 5 mm.

The slide holder will be designed with a width and a length varying by 2 mm with respect to the slide dimensions. The combination of the toes, of the pin, of the pusher, and of the springs will enable repositioning of a same microscopic preparation to within one half micrometer.

The associated step-by-step motor enables displacing the slide holder with a 0.1-μm accuracy, at a 50-mm/s speed.

The digital camera is of CMOS type, of a size of at least 1280×10²⁴ image points (pixels) such as, for example, the PB=MV13 Megapixel CMOS device sold by Photobit Company of Pasadema, Calif., USA, having a limiting frame speed on the order of 2 ms per frame (500 frames per second), for which acquisition performances with the various objectives are the following.

The motors of the strong and low magnification heads are similar. Each one moves the associated head at a speed ranging between 1 and 10 cm/s. The speed selection will be performed according to the acquisition conditions (active objective, light source type . . . ).

The reconstruction means selects the speed either automatically, or under instruction of an observer.

For a 4× objective, a total time ranging between 4 and 30 s, for example, 13 s, is necessary to acquire a navigation image with an optical resolution on the order of 3 μm.

For a 10× objective, the optical resolution is on the order of 1.2 μm, and the entire useful portion of the microscopic preparation is acquired within a time ranging between 60 and 200 s, for example, on the order of 60 s.

For a 20× objective, a succession of images of an optical resolution of 0.7 μm will be obtained, for the entire useful portion of the microscopic preparation, within a time ranging between 170 and 500 s, for example, on the order of 370 s.

For a 40× objective, the acquisition of a succession of images, of an optical resolution of 0.5 μm is performed, for the entire useful portion of the microscopic preparation, within a time ranging between 400 and 1000 s, for example, on the order of 700 s.

The passing time of a high-resolution image obtained with the 10×, 20×, or 40× objectives from a position defined in the navigation image ranges between 0.1 and 1 s, for example, on the order of 0.25 s.

The passing time from a high-resolution image obtained with the 10×, 20×, or 40× objectives to another adjacent image obtained with the same objective ranges between 0.1 and 0.5 s, for example, on the order of 0.25 s.

Of course, the present invention is likely to have various alterations, modifications, and improvements which will readily occur to those skilled in the art. In particular, the displacement or hold systems may differ from those described hereabove. Similarly, the distribution of the various components performed in any of the drawings is an illustration only. Thus, the two read heads 41 and 42 of FIG. 4 may be arranged on a different side of the slide. Similarly, the acquisition system (semitransparent plate 11, digital camera 9, contrast diaphragm 12) may differ from that discussed in relation with FIGS. 3 and 4.

1. A microscope comprising at least one optical device (6; 41, 42) for magnifying a preparation slide (46) placed on a rectangular slot (3) so that the entire length of the slide at least partially covers the slot length, the slot width being smaller than that of the slide, characterized in that it further comprises:
means (10; 431, 441, 432, 442, 45, 46) for moving the optical device lengthwise over the slot along said entire length;
a slide holder (1) for moving the slide widthwise over the slot across the entire slide width;
a digital camera (9) associated with the optical device; and
means for reconstructing (50) a partial or full image of the slide, based on the succession of lines and columns filmed by the camera during the motions of the device and of the slide holder.

2. The microscope of claim 1, wherein said at least one optical device (6; 41, 42) comprises first and second immovably attached portions, capable of passing, respectively, under and over the rectangular slot (3) upon displacement of the device, the first portion comprising at least one lighting device (7, 70, 71) and the second portion comprising at least one objective (8; 81, 82, 83) placed on the optical axis defined by the lighting device and the slot.

3. The microscope of claim 2, wherein the lighting device (7) of the first portion comprises at least one light source.

4. The microscope of claim 3, wherein at least one light source is assembled on the optical device.

5. The microscope of claim 3, wherein at least one light source is external to the device and wherein an optical fiber brings into the first portion of the magnifying optical device (6; 41, 42) the beam emitted by the source.

6. The microscope of any of claims 3 to 5, wherein at least one light source is a continuous source.

7. The microscope of any of claims 3 to 5, wherein at least one light source is a pulsed source.

8. The microscope of any of claims 3 to 7, wherein the lighting device (7) further comprises a focusing lens (70), attached in the first portion of the magnifying optical device (6; 41, 42), whereby a light beam originating from the light source is condensed towards the slot (3).

9. The microscope of claim 8, wherein the lighting device (7) further comprises a diaphragm (71) interposed between the lens (70) and the slot (3).

10. The microscope of any of claims 2 to 8, wherein the second portion of the magnifying optical device (6; 41) comprises a plurality of objectives (81, 82, 83) and a selection means capable of placing a single one of the objectives on the optical axis.

11. The microscope of claim 10, wherein the selection means comprises a step-by-step controllable motor (85) capable of moving perpendicularly to the optical axis a drawer (84) containing the plurality of objectives (81, 82, 83).

12. The microscope of any of claims 2 to 11, wherein the second portion of the optical device (6; 41, 42) further comprises a self-focusing means for moving the objective (8; 81, 82, 83) along the optical axis.

13. The microscope of claim 12, wherein the self-focusing means comprises a laser diode (13) placed on the optical axis above the objective (8; 81, 82, 83), a piezo-electric element (86) associated with the objective and controlled by the reconstruction means (50).

14. The microscope of any of claims 1 to 13, wherein the means for displacing the magnifying optical device (6; 41, 42) comprises at least one control element (441, 442) driven by a step-by-step controllable motor (451, 452).

15. The microscope of any of claims 1 to 14, comprising two magnifying optical devices, a first high-magnification device (41) and a second low-magnification device (42), each device being associated with its own displacement means (431, 441, 451, 432, 442, 452).

16. The microscope of any of claims 1 to 15, wherein the slide holder (1) is rectangular and exhibits a U shape of a length at least equal to that of a slide (46).

17. The microscope of claim 16, wherein a control element (61) connects a stop portion of a slide (46) in the slide holder (1) to a step-by-step motor (60) controllable by the reconstruction means (50).

18. The microscope of claim 16 or 17, wherein the slide holder (1) further comprises a fixed portion (29) supporting an optotype (30).

19. The microscope of any of claims 1 to 18, wherein the means for moving the optical device (6; 41, 42) and the slide holder (1) for moving the slide output their position in real time to the reconstruction means (50).

20. The microscope of any of claims 1 to 19, wherein the digital camera (9) is a CMOS camera.

21. The microscope of claims 2 and 20, wherein the digital camera (9) associated with the magnifying optical device (6; 41, 42) is placed in the second portion thereof.

22. The microscope of claim 21, wherein the second portion further comprises a means (11) for transmitting to the digital camera (9) the light beam coming out of the objective (8; 81, 82, 83).

23. The microscope of claim 22, wherein the transmission means is a semitransparent plate (11).

24. The microscope of claim 23, wherein a diaphragm (12) is interposed between the semitransparent plate (11) and the digital camera (9).
